(19) United States
(12) Patent Application Publication
(10) Pub. No.: US 2014/0358917 A1
(43) Pub. Date: Dec. 4, 2014

(54) SYSTEM AND METHOD FOR REMOTE IMAGE ORGANIZATION AND ANALYSIS

(71) Applicant: Duke University, Durham, NC (US)

(72) Inventor: George Allan Johnson, Chapel Hill, NC (US)

(73) Assignee: Duke University, Durham, NC (US)

(21) Appl. No.: 14/372,868

(22) PCT Filed: Jan. 23, 2013
(86) PCT No.: PCT/US2013/022751

§ 371 Date: Jul. 17, 2014

Related U.S. Application Data
(60) Provisional application No. 61/589,501, filed on Jan. 23, 2012.

(51) Int. Cl. G06F 17/30; H04L 29/08

(52) U.S. Cl. CPC G06F 17/30244; H04L 67/12
USPC 707/736

(57) ABSTRACT

A system for remote image organization and analysis. The system includes at least one remotely-accessible computer including a processor, and a software program stored on a non-transitory computer readable medium accessible by the processor. The software program is operable to access at least one multi-dimensional library of image data stored on a storage medium, supplement the library by adding at least one new image to the library, share at least one image in the library between a plurality of users, wherein at least one user remotely accesses the computer, and perform at least one computational or analytical function related to an image in the library.

### CROSS-REFERENCE TO RELATED APPLICATIONS

This application claims priority to U.S. Provisional Patent Application No. 61/589,501, filed Jan. 23, 2012, the content of which is incorporated herein by reference in its entirety.

### GOVERNMENT SUPPORT

This invention was made with government support under Grant Number P41RR05959 awarded by the NIH/NCRR. The government has certain rights in the invention.

### FIELD OF THE INVENTION

The invention generally relates to medical and biological imaging, and more particularly to a system and a method for remote organization and analysis of medical and biological images.

### BACKGROUND

Medical imaging has developed tremendously in the past twenty five years and is now used in many different areas (e.g., in basic sciences, in engineering, and in various computer simulations). The world's first commercial compute tomography (CT) system (EMI Mark I) generated two 80×80 image arrays (approximately 24 KB) in fifteen minutes. In contrast, the newest CT scanners can readily generate one thousand 512×512 images in less than one minute (approximately 500 MB). Even larger four-dimensional (4D) cardiac arrays, in which three spatial dimensions are viewed over the additional dimension of time, are rapidly becoming routine. Imaging is now ubiquitous in modern medicine. In addition, imaging has become a critical tool for the basic sciences. In addition, the dimensions of the images arrays there also grown rapidly. The first available magnetic resonance (MR) image was 20×20. Recent three-dimensional (3D) microscopic MR images of the rat brain have been acquired on 1024×1024×2048 (4 GB) arrays. At the same time, the dimensionality of these data has increased. Diffusion tensor MRI data now routinely yields 3D spatial arrays, where each element of the array is a (3×3 dimensional) tensor. Virtually every field of science has their own massive collections of data (e.g. the sky maps in astronomy, finite element models in engineering, population maps in ecology, etc.). Furthermore, that data continues to grow in raw size and dimensionality.

The human eye can only observe the above-identified data on a two-dimensional (2D) screen. The field of visualization has evolved to meet the challenges of “wrapping our heads” around larger dimensions, a third dimensional in space, a fourth dimension in time, a fifth dimension is spectral energy, etc. As the ease with which we can generate these multidimensional arrays has increased, there has been yet one more dimension added to the mix—the need to analyze and compare two, four and more sets of images—the generation of probabilistic, average, and difference sets. In addition, there is another urgent need—to share the generated image data quickly across multiple users and to allow these users to efficiently analyze and manipulate the image data.

### SUMMARY

As noted above, the expanding size and dimensionality of the image data generated by various imaging systems have created the field of “visualization.” Specialized hardware systems and software tools have been developed to allow doctors and/or researchers to view and explore the image data generated by the various imaging systems.

The existing systems and tools are only configured to process and distribute medical images to various users that are part of an internal network (e.g., a hospital, a research facility, etc.). These systems are generally located in the facility where the images are generated and require the use of specific hardware and software for their operation. Consequently, these systems can only be used by users that have physical access to the systems and that restricts the accessibility of the systems. Further, the exiting systems frequently require storing the generated image data locally on the systems. This makes it difficult for users outside of the external network to share and analyze these images without actual physical data transfer of the images to a similar system. Therefore, the current systems do not provide an open framework to enable users outside of the internal network or one without a physical access to the system to view and analyze the stored medical images. In addition, these exiting systems do not provide third-parties with the opportunity to remotely add new external images to the locally stored images or to perform any type of comparison analysis between the locally stored images and any external images.

These limitations restrict the ability of outside users of the generated medical images to access, edit, and analyze the images in a timely and sufficient matter. For example, if two scientists located in different hospitals wanted to simultaneously analyze and compare an image gendered by a scanner in one of the hospitals, they have to transfer the image to two separate systems in each hospital. Each of these systems could be designed to use its own software. These restrictions complicate and slow down the analysis of the images. Therefore, there is a need for an improved system and a method for remote organization and analysis of large multidimensional (medical and biological) images.

The system for remote image organization and analysis described herein is designed to provide medical personal, scientists, researchers, and every day users with easy and secure access to multi-dimensional thematic imaging libraries. The system further provides the computational tools to explore and analyze the images in these high dimensional libraries. The system uses cloud computing configuration that allows users to access the system via a cloud, and can provide entirely new ways to teach, publish, and learn in the cloud. The implementation of such remote access system will create great advantages for medical personal, scientists, and educators. It will enable users to efficiently create various libraries with medical data and to remotely access, supplement, and share the images in the libraries.

In one embodiment, the invention provides a system for remote image organization and analysis. The system includes at least one remotely-accessible computer including a processor, and a software program stored on a non-transitory computer readable medium accessible by the processor. The software program is operable to access at least one multi-dimensional library of image data stored on a storage medium, supplement the library by adding at least one new image to the library, share at least one image in the library between a plurality of users, wherein at least one user remotely accesses the computer, and perform at least one computational or analytical function related to an image in the library.

In another embodiment, the invention provides a computer implemented method for remote image organization and analysis. The method includes transferring image data to a remotely-accessible computer. The computer includes a processor and a software program stored on a non-transitory computer readable medium accessible by the processor. The method further includes accessing at least one multi-dimensional library of image data stored on a storage medium, supplementing the library by adding at least one new image to the library, sharing at least one image in the library between a plurality of users, wherein at least one user remotely accesses the computer, and performing at least one computational or analytical function related to an image in the library.

In yet another embodiment, the invention provides a system for remote image organization and analysis. The system includes at least one remotely-accessible computer including a processor, and a software program stored on a non-transitory computer readable medium accessible by the processor. The software program is operable to create at least one multi-dimensional library of image data, supplement the library by adding at least one new image to the library, share at least one image in the library between a plurality of users, wherein at least one user remotely accesses the computer, and perform at least one computational or analytical function related to an image in the library. The computer is connected in a cloud computing configuration and the library is remotely accessible by a plurality of users via a cloud.

Other aspects of the invention will become apparent by consideration of the detailed description and accompanying drawings.

### BRIEF DESCRIPTION OF THE DRAWINGS

FIG. 1 illustrates an example of computed tomography (CT) images generated by a CT system.

FIG. 2 illustrates an example of magnetic resonance imaging (MRI) images generated by MR system.

FIG. 3 illustrates a system for remote image organization and analysis according to an embodiment of the present invention.

FIG. 4 shows the modules of the system for remote image organization and analysis of FIG. 3.

FIG. 5 illustrates an exemplary image derived from a multi-dimensional “digital mouse” library of image data.

FIGS. 6 and 7 illustrate screens from multi-dimensional libraries of image data.

FIG. 8 is a flow chart illustrating a method of remote image organization and analysis performed by the system of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible. For example, “controllers” described in the specification can include standard processing components, such as one or more processors, one or more computer-readable medium modules, one or more input/output interfaces, and various connections (e.g., a system bus) connecting the components.

The invention described in this application relates to systems, methods, and computer readable media for remote image organization and analysis. The system is accessible by a plurality of users in a cloud computing configuration. The system allows users to create, access, and supplement a plurality of multi-dimensional libraries of medical image data. The system also includes a plurality of library-specific software protocols configured to perform computational or analytical functions related to the images in the libraries.

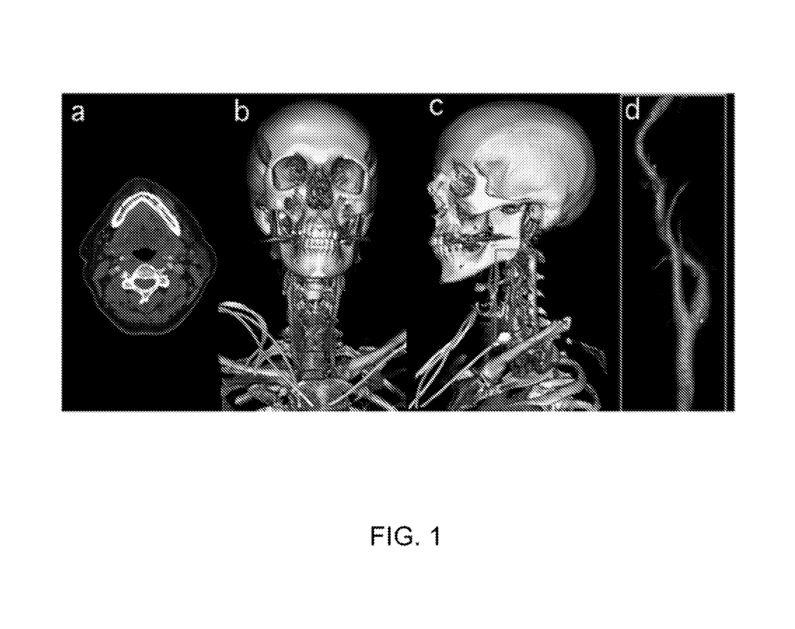

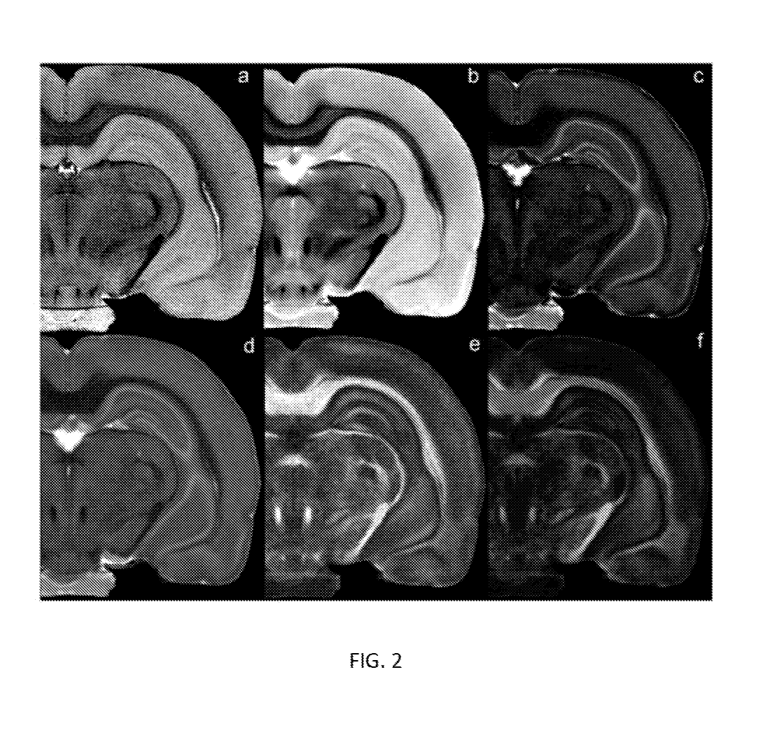

The data deluge from the modern clinical imaging systems is overwhelming. A typical modern CT scanner can generate one thousand 512×512 pixel images in less than twenty five seconds. FIGS. 1 and 2 illustrate examples of images generated by these imaging systems. FIG. 1 illustrates an example of clinical computed tomography (CT) images generated by a CT system. Specifically, FIG. 1a shows a single cross-sectional image (512×512×16 bits), representative of a standard dataset usually presented to a radiologist. Further, FIGS. 1b-c show volume images of the stack of 630 transverse images rendered to highlight the carotid arteries of a patient. FIG. 1d shows a left carotid bifurcation extracted explicitly for determining the degree of obstructive vascular disease.

FIG. 2 shows selected slices from a magnetic resonance (MR) microscopy of the rat brain at 200,000-times the resolution that is common in clinical MR imaging. The illustrated images are part of a multidimensional atlas of the rat brain. Brains from five animals at ten different time points have been scanned at spatial resolution of 25 μm. Each specimen has been imaged with multiple techniques to provide a comprehensive picture of rat neuroanatomy during critical stages of development. The total complement of data is more than 1 terabyte (TB). FIGS. 2(a, b) show images of the adult rat with two different acquisition strategies chosen to highlight subtle contrast differences. FIGS. 2(c-f) are derived from seven different acquisitions with magnetic gradients applied along different axes. These allow one to calculate a tensor at each point in the image that encodes information about the microstructure of the brain.

Medical personal and scientist have powerful imaging work stations and systems that help them to organize and analyze the generated image data. However, the sophisticated comparison of volume images, diffusion tensor analysis, and other important analytical functions can only be performed locally, at a specific work station by an imaging expert who has an access to the particular system. The existing work stations and systems do not allow multiple outside users to view and analyze medical images that are stored locally or to remotely upload new external images to the local work station. The system will allow physicians studying different medical conditions (e.g., dementia, pulmonary insufficiency, or multiple sclerosis) to capture the unique clinical images they see every day and to store them in thematic data libraries. The images in these libraries will be available to view, share, and study in a cloud based environment and will become a part of the user's routine for teaching and publication.

Therefore, the present image data deluge will be tamed by providing sophisticated software tools for image display and analysis. The system will offer many advantages to medical personnel, scientists, etc. New diagnostic models will emerge because users can routinely upload one or more datasets to a library, register the data to an average, and determine quantitatively the change in hippocampal volume in an Alzheimer's disease patient relative to a statistical atlas. Basic scientists will benefit in a similar fashion as they explore rodent models of human diseases. Students at all levels will benefit from the curated knowledge available in these libraries. Scientists wishing to publish in peer review or other journals will benefit as they are allowed to supplement the limitations of the static page with more dynamic and interactive material.

FIG. 2 illustrates system 10 for remote image organization and analysis. The system includes a main computer (e.g., a server) 15 that is in communicating with a plurality of user stations (e.g., computers, tablets, etc.) 20 via a network 22. The computer 15 may also be connected to an imaging device or an imagining system 25 that generates one or more medical images or a thematic dataset. In some embodiments, the imaging systems 25 may include a computed tomography (CT) system, a positron emission tomography (PET) system, or a MRI system. In other embodiments, other types of imaging systems can be used.

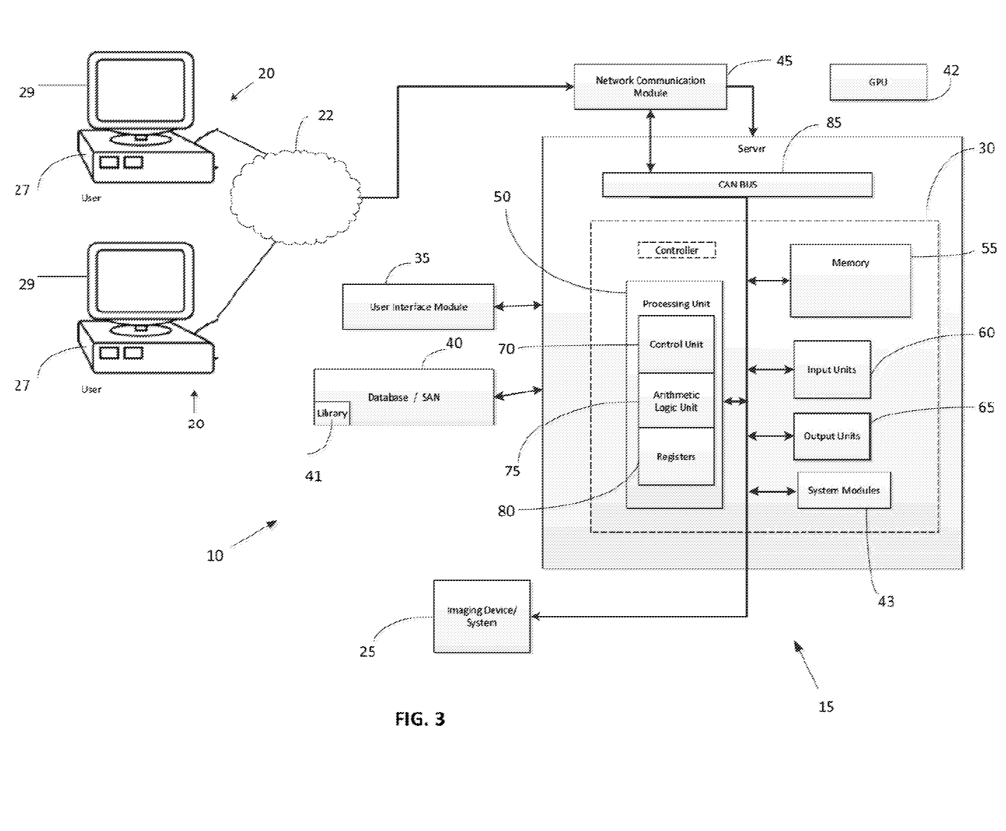

The user stations 20 may include a computer 27 and a screen 29. In some embodiments, the computer 27 and the screen 29 of the user stations 20 are combined in a single device. Also, in some embodiments, the user stations 20 may include peripheral devices, such as a keyboard, mouse, printer, etc., connected to the computer 27 and/or the screen 29. In addition, it should be understood that in some embodiments, a monitor is used in place of or in addition to the screen. As described in more detail below with respect to FIG. 3, the computer 15 is configured to receive and store data generated by the imaging system 25, create and access at least one multi-dimensional library of image data, supplement the library by adding at least one new image to the library, share at least one image in the library between a plurality of user stations 20, and perform at least one computational or analytical function related to an images in the library.

The main computer 15 and the user stations 20 include software code in a browser-supported language (e.g., JavaScript, etc.) combined with a browser-rendered markup language (e.g., HTML). As explained in more details below, the network 22 illustrated in FIG. 1 is a part of a cloud computing configuration. The network 20 can be the Internet, but other types of networks can also be used. In one embodiment, the system 10 is configured to be viewed through a browser application (not shown) residing on the user stations 20. The browser application is one means for accessing a website. When a user on a user station 20 wishes to access the computer 15, the user station 20 initiates a browser application (not shown) located on user station 20.

FIG. 1 further illustrates a controller 30 associated with the system 10. Generally, the controller is located on the computer 15. The controller 30 provides the overall control functions of the system 10, including operating a software code for remote image organization and analysis. The controller 30 is electrically and/or communicatively connected to a variety of modules or components of the system 10. For example, the illustrated controller 30 is connected to a user interface module 35, a database 40, a graphics processing unit (“GPU”) 42 (e.g., Kepler GPU, Tesla GPU, etc.), and a network communications module 45. The controller 30 includes combinations of hardware and software that are operable to, among other things, control the operation of the system 10. The database 40 (e.g., a storage area network) includes one or more multi-dimensional libraries 41 of image data.

In some embodiments, the controller 30 includes a plurality of electrical and electronic components that provide operational control and protection to the components and modules within the controller 30 and/or system 10. For example, the controller 30 includes, among other things, a plurality of system modules 42, a processing unit 50 (e.g., a microprocessor, a microcontroller, or another suitable programmable device), a memory 55, input units 60, and output units 65. The processing unit 50 includes, among other things, a control unit 70, an arithmetic logic unit (“ALU”) 75, and a plurality of registers 80 (shown as a group of registers in FIG. 3), and is implemented using a known computer architecture. The processing unit 50, the memory 55, the input units 60, and the output units 65, as well as the various modules 42 connected to the controller 30 are connected by one or more control and/or data buses (e.g., common bus 85). The input units 60 and the output units 65 transmits data from the controller 30 to external systems, networks, and/or devices and receives data from external systems, networks, and/or devices. In particular, the input/input units 60 and the output units 65 communicate with the user stations 20 via the user communication module 45. The control and/or data buses are shown generally in FIG. 3 for illustrative purposes. The use of one or more control and/or data buses for the interconnection between and communication among the various modules and components would be known to a person skilled in the art in view of the invention described herein.

The memory 55 can include, for example, combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 50 is connected to the memory 55 and executes software instructions that are capable of being stored in a RAM of the memory 55 (e.g., during execution), a ROM of the memory 55 (e.g., on a generally permanent basis), or another non-transitory computer readable medium such as another memory or a disc. Software included in the implementation of the system 10 can be stored in the memory 55 of the controller 30. The software includes, for example, firmware, one or more applications, program data, filters, rules, one or more program modules, and other executable instructions. The controller 30 is configured to retrieve from memory and execute, among other things, instructions related to the control processes and methods described herein. In other constructions, the controller 30 includes additional, fewer, or different components.

The network communications module 45 is connectable to and can communicate through the network 22. In one embodiment, the network 22 is a part of a cloud computing configuration operated by the system 10. In a cloud computing configuration, users access and utilize various computing recourse (e.g., hardware, application software, databases, etc.) that are delivered as a service over a network (e.g., the Internet). The cloud providers manage the infrastructure and platforms on which the applications in the system 10 run. Therefore, the main computer 15, its elements and components are part of the network 22. The user stations 20 access the computer 15 and the various data and applications stored on the computer 15 via the network 22.

In some embodiments, the network 22 is, for example, a wide area network (“WAN”) (e.g., a TCP/IP based network, a cellular network, such as, for example, a Global System for Mobile Communications [“GSM”] network, a General Packet Radio Service [“GPRS”] network, a Code Division Multiple Access [“CDMA”] network, an Evolution-Data Optimized [“EV-DO”] network, an Enhanced Data Rates for GSM Evolution [“EDGE”] network, a 3GSM network, a 4GSM network, a Digital Enhanced Cordless Telecommunications [“DECT”] network, a Digital AMPS [“IS-136/TDMA”] network, or an Integrated Digital Enhanced Network [“iDEN”] network, etc.).

In other embodiments, the network 22 is, for example, a local area network (“LAN”), a neighborhood area network (“NAN”), a home area network (“HAN”), or personal area network (“PAN”) employing any of a variety of communications protocols, such as Wi-Fi, Bluetooth, ZigBee, etc. The connections between the network communications module 45 and the network 22 are, for example, wired connections, wireless connections, or a combination of wireless and wired connections. Similarly, the connections between the controller 30 and the network 22 or the network communications module 45 are wired connections, wireless connections, or a combination of wireless and wired connections. In some embodiments, the controller 30 or network communications module 45 includes one or more communications ports (e.g., Ethernet, serial advanced technology attachment [“SATA”], universal serial bus [“USB”], integrated drive electronics [“IDE”], etc.) for transferring, receiving, or storing data associated with the system 10 or the operation of the system 10.

The processor 50 of the controller 30 sends control signals to control the operations of the remote image organization and analysis system 10. For example, the controller 30 can control, among other things, remotely creating and accessing of multi-dimensional libraries with image data, remotely supplementing the libraries by adding new images, sharing images from the libraries between a plurality of users that have a remote access to the computer, and performing computational and analytical functions related to images in the library.

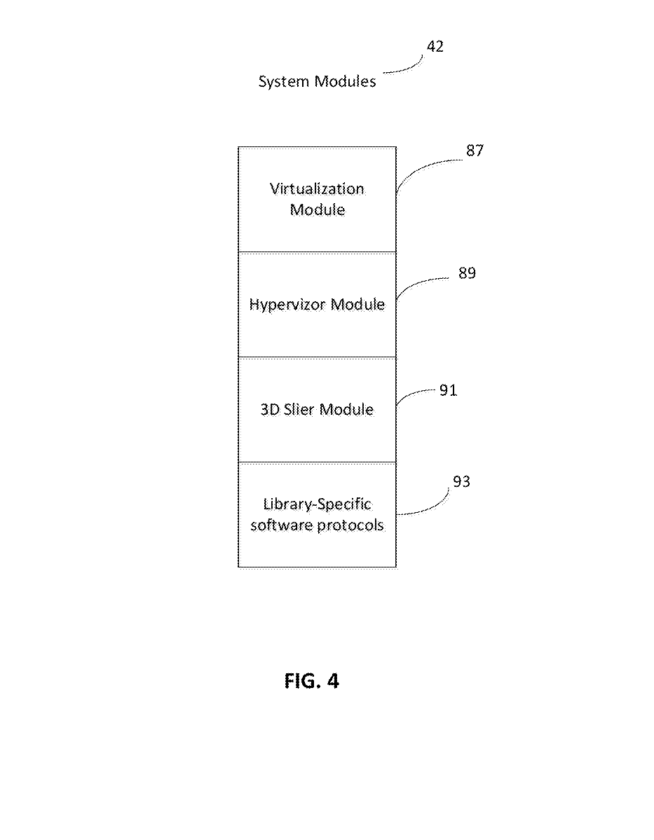

The system modules 43 of the computer 15 are operable to implement the operational functionality of the remote image organization and analysis system 10 in a cloud based configuration. The system modules 43 further interact with the GPU 43 and the controller 30 to provide imagining and visualization functions to the user stations 20. FIG. 4. illustrates the system modules 42 in more detail. The system modules 42 include a virtualization module 87, a hypervisor module 89, a 3D Slicer module 91, and library-specific software protocols. The virtualization module 87 (e.g., NVIDIA, Citrix, etc.) includes software that provides specific functionality that allows the main computer 15 to connect and commutate with the user stations 20 via the network 22. The hypervisor module 89 includes software that manages multiple guest operating systems (i.e., of the various user stations 20) that are in communication with the main computer 15 during virtualization of the system 10. The 3D Slicer module 91 includes software for image analysis and scientific visualization. This is the main tool that is used by medical personnel, scientists, and others to view and analyze the images stored on the system 10. Among other things, the 3D Slicer module 91 provide image registration, processing of diffusion tensor imaging (“DTI”) data for tractography, GPU-enabled volume rendering, and an interface to external devices for image guidance support. As described in more details below, the library specific software protocols 93 are software tools associated with the libraries of the system 10. The library-specific software protocols 93 are configured to perform computational or analytical functions related to the images in the libraries.

The controller 30 and the control system described above are used to implement the remote image organization and analysis performed by the system 10. As mentioned above, the database 40 of the computer 15 is operable to store one or more multi-dimensional libraries 41 of image data. That way, the system 10 provides an opportunity to create a variety of different libraries 41 that are of interest to medical personal, scientists, educators, and others. In one embodiment, the images are directly transferred to the libraries 41 from the imaging system 25. In other embodiments, the images in the libraries 41 are stored in the database 40 from another source. The libraries 41 can include different types of thematic image datasets. For example, the libraries can include cardiac image data, neural image data, animal image data, etc. The cloud-based configuration of the system 10 provides an opportunity to remotely store in the “cloud” very large thematic datasets (containing, e.g., terabytes of data). The system 10 can include a variety of libraries 41 and the libraries listed below only represent an example of the different type of image data that can be included in the system 10.

Library Type (Library size shown in ( ))
A. Human library (includes three-dimensional CT head images,
three-dimensional MR brain images,
and four-dimensional CT or MR heart images):

| | | |
|---|---|---|
| 50 3D Head CT Angiography Cases showing | (14 | TB) |
| Normal Aging | | |
| Aneurysms in the brain | | |
| Representative neoplasia and their evolution | | |
| 50 3D MR Studies in the brain showing | (170 | GB) |
| Normal aging | | |
| Dementia (Alzheimers) | | |
| 25 4D CT or MR studies in the heart showing | (6.7 | TB) |
| Normal Aging | | |
| Infarcts | | |
| Cardiac Insufficiency | | |

B. Mouse Library (includes three-dimensional MR images of a whole
mouse, four-dimensional MicroCT images of the mouse heart, and
three-dimensional microscopy images of the mouse brain)

| | | |
|---|---|---|
| 18 3D images of the C57/BL6 mouse showing | (25 | GB) |
| growth from Embryonic stage 9.5 through 19.5 | | |
| postnatal growth from birth to adult | | |
| 24 3D MR images of the whole mouse showing | (2.6 | TB) |
| Male/Female differences in | | |
| 12 most frequently used strains | | |
| 25 4 D MicroCT images of the mouse heart | (40 | TB) |
| showing | | |
| Normal function | | |
| Variation in genetic modals | | |
| Quantitative motion analysis | | |
| 100 3D MR Microscopy images of the mouse | (100 | TB) |
| brain showing | | |
| Normal variation of the C57BL/6J | | |
| Strain variations in the BXD mouse | | |
| Angiography | | |
| Multiple MR contrasts | | |
| Associated histology | | |
| Structure segmentation | | |

C. Library of the Natural World- 3 and 4D MR and CT data at
microscopic resolution showing

| | | |
|---|---|---|
| Anatomy of insects (at 25 um MRI) | (5 | TB) |
| Choclea of a mouse and a bat (MRI at 20 um) | | |
| 4D time lapse MR showing plant growth | | |
| (MRI at 25 um ×20 time points) | | |
| Anatomy of a tomato (MRI) | | |
| Anatomy of a lemon (MRI) | | |

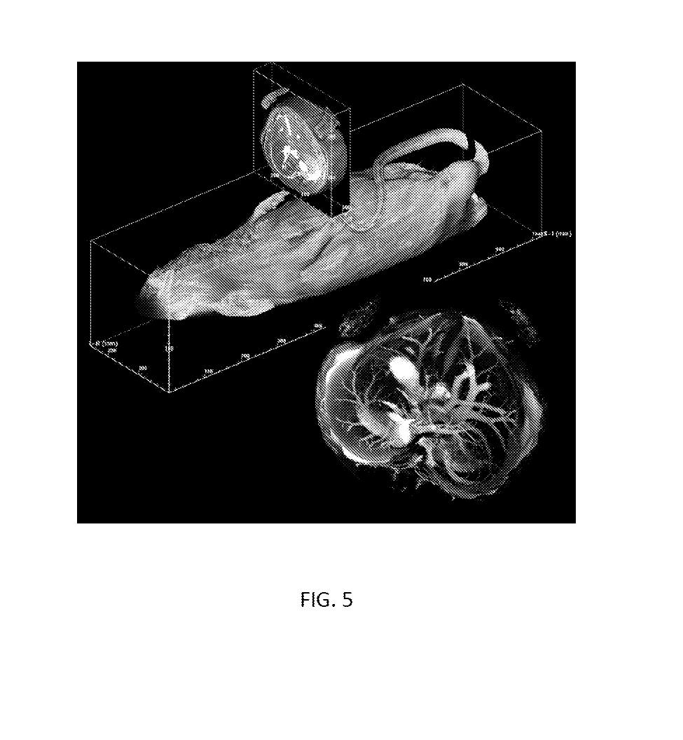

Other types of libraries may also include: 1) Libraries related to basic science: MRI or diffusion tensor imaging (“DTI”) atlases of the mouse and rat brain; atlas of various mammalian species (e.g., gerbil, guinea pig, macaque, monkey, etc.); MicroCT library of cardiac function in the rodent; other atlases with MRI, microCT, microPET, confocal images; 2) Libraries related medical imaging: libraries related to clinical training of radiologists, cardiologist, neurologists, etc.; an atlas of the normal variability in Alzheimers Disease; case studies of cardiopulmonary disease as depicted by CT; various atlases used to enhance peer reviewed publications; 3) Educational and public libraries: a digital mouse library (shown in FIG. 5)—this is an interactive learning program for students that allows them to “slice up” a mouse from their own user station 20; a digital frog library; a digital embryo library; a human anatomy library.

In one embodiment, the libraries 41 are created by a system administrator. For example, the system administrator creates a number of libraries when he or she creates or updates the system 10. Further, the system administrator can add, delete, and rename libraries at any time. The administrator can also change the content of the libraries by adding, removing, and editing image datasets in the specific libraries. In other embodiments, the libraries 41 may be created and edited by a user of the system 10. In particular, a user may utilize a user station 20 (e.g., a personal computer) to access the system 10 and to create a new library or to add image data to an existing library. Nonetheless, all libraries 41 are located on the computer 15 (i.e., on a server). Therefore, all image data in the libraries is stored and remains in the “cloud” at all times and is accessible to a user via the “cloud.”

Each library 41 of the system 10 includes one or more library specific software protocols 93 that configured to perform computational or analytical functions related to the images in the libraries. A remote user can utilize these specific protocols to view, analyze, and compare, images included in the different libraries 41. In one embodiment, the software protocols include: a protocol for multidimensional sectioning for all images in the library; a protocol for maximum intensity projection with three-dimensional rendering for CT and MR angiography images; a protocol for composite rendering for gray scale rendering of MR images; and a protocol for three-dimensional rendering of the image on a user's computer.

Additional software protocols may also include: a protocol for comparison of multiple sections from multiple specimen; a protocol for comparison of multiple contrasts from multiple specimens; a protocol for volume rendered comparison of selected structures of interest; a protocol for dynamic (4D) beating heart with interactive digital scalpel; a protocol for cross sectional anatomy with labels of a rodent brain, heart, kidney, or a whole animal; a protocol for volume rendered anatomy of a rodent, of a human, of a patient's own CT or MR image. Further protocols may include: a protocol for comparative fusion (four or five dimensional) images of a heart from MR and microPET; a protocol for population averaging of multiple specimens to determine mean and variance of a given anatomical feature; and a protocol for registration (differences) between user's specimen (brain, heart, kidney, etc.) and a library 41. It is to be understood that the listed protocols are only provided as examples and the system 10 can include other protocols not mentioned herein.

By using the system 10, a remote user can view, analyze, and update various image data stored in the plurality of libraries 41 without downloading any images or image-processing software on his or her local computer. In particular, the processor 50 included in the computer 15 executes the user interface module 35 to display various screens to a user on the screen 29 of the user station 20. A user enters commands through the displayed screens using buttons on a peripheral devices (e.g., keyboard or a mouse, not shown) or the screen 29 (if this is a separate touchscreen) to initiate and perform various functions with the images included in the libraries 41. To start the process, a user creates an account or logs into an existing account profile. A login screen will be generated and displayed by the controller 30 on the screen 29 of the user station 20. In one embodiment, the login screen will prompt the user for a username and password and will display a ‘next’ or ‘enter’ button.

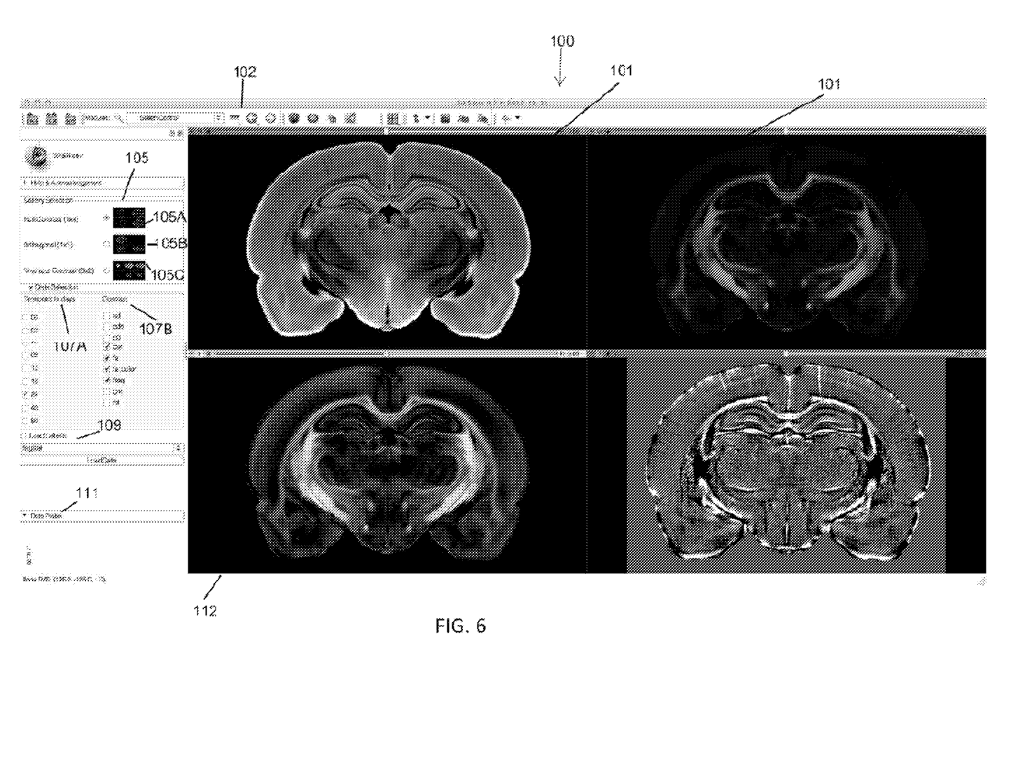

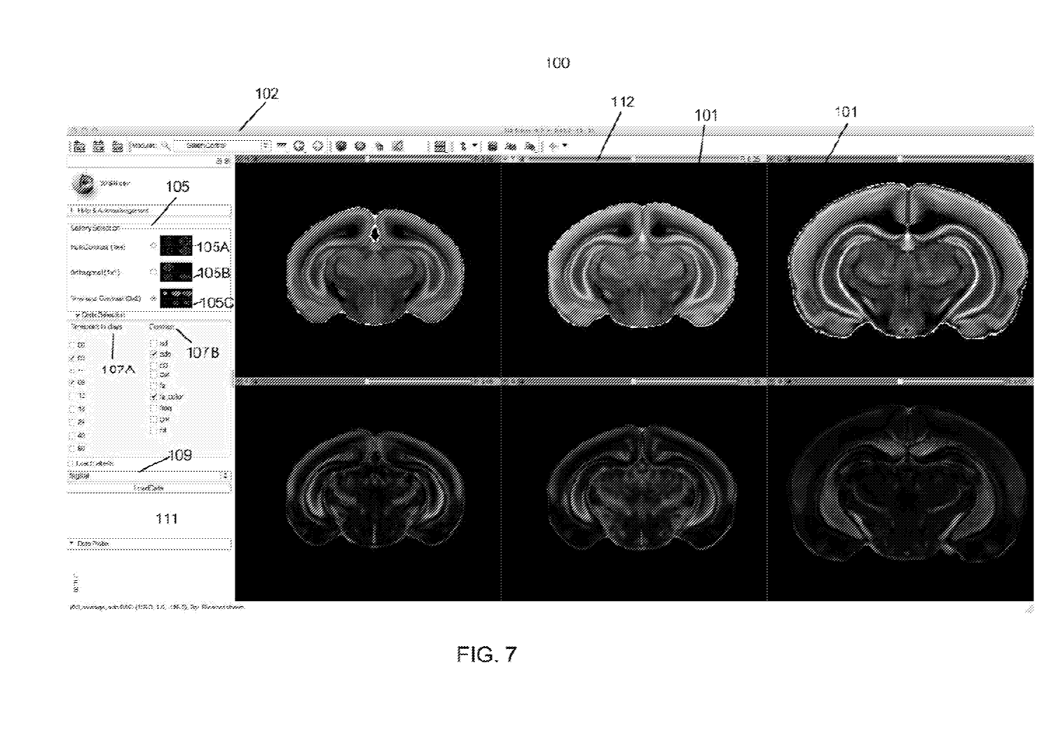

After logging in, the user will be prompted to select a specific image library, to search for a library, or to create a new library. The system 10 is configured to allow all remote users to create new libraries 41 or to supplement one or more libraries in the database 40 by adding at least one new image to an existing library 41. By implementing the various hardware components and software tools of the system 10, a user can view images in different libraries, share images with other remote users, and perform various computational and analytical functions related to images in the libraries. FIGS. 6 and 7 illustrate screens 100 with images from libraries 41 generated and displayed by the system 10. In the illustrated embodiment, the screens 100 are from the developing rat library. The illustrated images from the library show how the brain of a rat develops by using various MRI image data.

The screens 100 in FIGS. 6 and 7 include a plurality of images 101, a toolbar 102 with various operating buttons, a gallery selection section 105, a data selection section 107, a view section 109, and a data probe section 111.

The gallery selection section 105 includes three galleries or software protocols for displaying and organizing the medical images in the library 41. These protocols assist a user to display the selected images in a desired configuration. Specifically, the gallery selection section 105 includes a Multicontrast protocol 105A, a orthogonal protocol 105B (shows one data set, one contrast, and provides three different plains in 3D and volume rendered image), and time and contrast protocol 105C (shows several different time points of the brain), and a protocol 105D for full 3D rendering of the images.

The data selection section 107 includes a “timepoint in days” subsection 107A that allows a user to select the number of different images to be displayed. These images represent specific dates and times at which the gallery 41 was sampled and updated (e.g., at birth (date 00), at two days after birth (date 02), etc.). The data selection section 107 further includes a “contrast section” 107B that allows a user to select different views of the generated images. For example, the “adc” contrast shown how rapidly the protons in the brain can diffuse, and the “fa_color” contrast shows the derivation from a diffusion tensor scan.

The view section-109 includes the possible views of the desolated image available to the user. These views may include a coronal view, a sagittal view, a transverse view, or other suitable views. The user may operate a slider 112 or other tool to navigate through the displayed images of the library.

Therefore, FIG. 6 shows a multicontrast view of day 22 of the rat brain development with four different contrast modes selected. FIG. 7 is a time and contrast view of days 2, 4, and 8 of the rat brain development with two contrast modes selected. The disclosed system allows users to compare various images from the libraries in different views and configurations. The system further allows a user to upload a new image and to compare that image with the images available in the libraries. Therefore, the system provides a greater advantage to the currently exiting machines and/or systems that do not provide such capabilities.

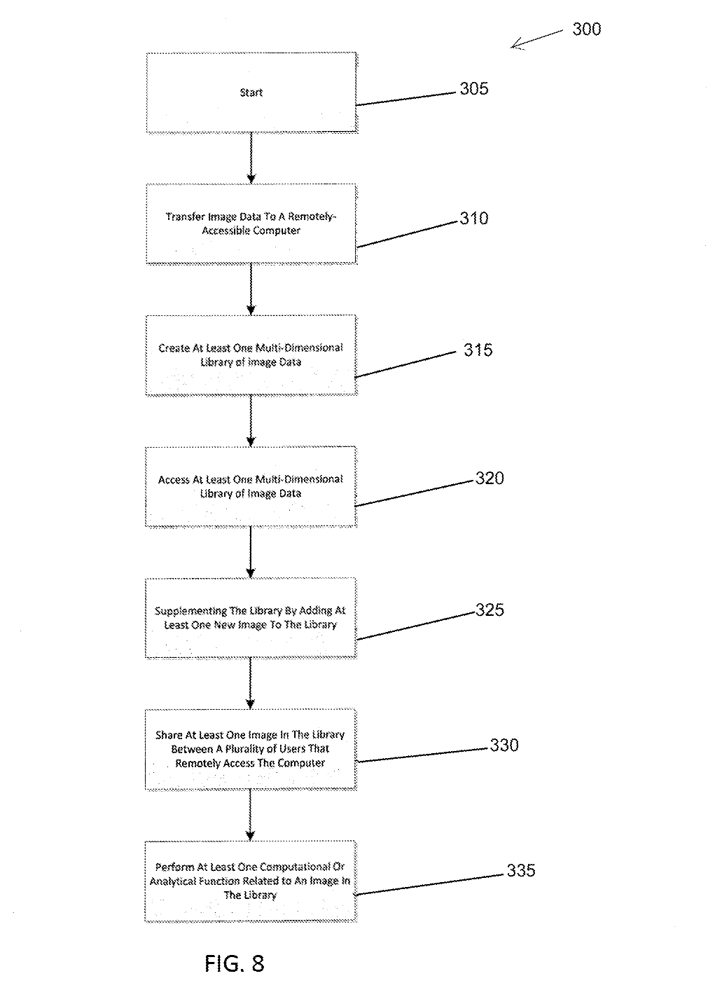

An implementation of a method for remote image organization and analysis for the system 10 is illustrated with respect to the process 300 of FIG. 8. The process 300 is associated with and described herein with respect to the image organization and analysis system 10. The process 300 can be executed by the controller 30. Various steps described herein with respect to the process 300 are capable of being executed simultaneously, in parallel, or in an order that differs from the illustrated serial manner of execution. The process 300 is also capable of being executed using additional or fewer steps than are shown in the illustrated embodiment.

As shown in FIG. 8, the process 300 begins with transferring or storing image data to the libraries 41 of the database 40 (at step 310). In some embodiments, the imaging system 25 directly sends the images to the libraries 41. In other embodiments, the images in the libraries 41 are stored in the database 40 from another source. In the next step (at 315), the controller 30 creates at least one multi-dimensional library of image data. Next, by using by using a user station 20 and the controller 30, a user can access at least one multi-dimensional library of image data (at step 320).

A remote user of the system 10 supplements a library 41 by adding at least one new image to the library (at step 45). A user can also add multiple images to a library 41. Alternatively, a user can remove images from a library 41 that he or she created but not from a “public” library created by the system administrator. The system 10 allows at least one image in the libraries 41 to be shared between a plurality of users that remotely accesses the computer (at step 330). In particular, every registered user can view the image libraries created by the administrator or by the other users in the cloud. Therefore, a user can take advantage of the images uploaded by someone else immediately because they are immediately made available by the system 10. In order to analyze or coma pare images from the different libraries 41, a user does not need to download and save an image to a local machine or system. The hardware and software of the system 10 (e.g., the system module 42) provide the user with all necessary software tools for image rendering and analysis of the images in in the cloud.

In the last step, by using the controller 30, a user can perform at least one computational or analytical function related to images in the library (at step 335). As noted above, the library-specific software protocols are stored in the controller 30 and are executed by the processor 50.

Thus, the invention provides, among other things, systems, methods, and computer readable media for remote image organization and analysis. Various features and advantages of the invention are set forth in the following claims.

1. A system for remote image organization and analysis, the system comprising:
at least one remotely-accessible computer including a processor; and
a software program stored on a non-transitory computer readable medium accessible by the processor, the software program being operable to
access at least one multi-dimensional library of image data stored on a storage medium,
supplement the library by adding at least one new image to the library,
share at least one image in the library between a plurality of users, wherein at least one user remotely accesses the computer, and
perform at least one computational or analytical function related to an image in the library.

2. The system of claim 1, wherein the software program is further operable to create at least one multi-dimensional library of image data.

3. The system of claim 1, wherein the software program is further operable to simultaneously compare information from multiple images in the library.

4. (canceled)

5. The system of claim 1, wherein the images include a thematic dataset obtained from at least one of a computed tomography (CT) system, a positron emission tomography (PET) system, and a magnetic resonance imaging (MRI) system.

6. (canceled)

7. The system of claim 1, further comprising a plurality of library-specific software protocols configured to perform the at least one computational or analytical functions related to the images in the library.

8. The system of claim 7, wherein the software protocols include a protocol for multidimensional sectioning for all images in the library.

9. The system of claim 7, wherein the software protocols include a protocol for maximum intensity projection with three-dimensional rendering for CT and MR angiography images.

10. The system of claim 7, wherein the software protocols include a protocol for composite rendering for gray scale rendering of MR images.

11. The system of claim 7, wherein the software protocols include a protocol for three-dimensional rendering of the image on a user's computer.

12. The system of claim 1, further comprising a database included in a cloud computing configuration and operable to store the multi-dimensional libraries with images.

13. The system of claim 1, wherein the libraries include a human library that comprises three-dimensional CT head images, three-dimensional MR brain images, and four-dimensional CT or MR heart images.

14. The system of claim 1, wherein the libraries include a mouse library that comprises three-dimensional MR images of a whole mouse, four-dimensional MicroCT images of the mouse heart, and three-dimensional microscopy images of the mouse brain.

15. (canceled)

16. A computer implemented method for remote image organization and analysis, the method comprising:
transferring image data to a remotely-accessible computer, the computer including a processor and a software program stored on a non-transitory computer readable medium accessible by the processor;
accessing at least one multi-dimensional library of image data stored on a storage medium;
supplementing the library by adding at least one new image to the library;
sharing at least one image in the library between a plurality of users, wherein at least one user remotely accesses the computer; and
performing at least one computational or analytical function related to an image in the library.

17. The method of claim 16, further comprising creating at least one multi-dimensional library of image data

18. The method of claim 16, further composing simultaneously comparing information from multiple images in the library.

19. (canceled)

20. The method of claim 16, wherein the images include a thematic dataset obtained from at least one of a computed tomography (CT) system, a positron emission tomography (PET) system, or a magnetic resonance imaging (MRI) system.

21. (canceled)

22. The method of claim 16, further comprising executing a plurality of library-specific software protocols configured to perform the at least one computational or analytical functions related to the images in the library.

23. The method of claim 22, wherein the software protocols include a protocol for multidimensional sectioning for all images in the library.

24. The method of claim 22, wherein the software protocols include a protocol for maximum intensity projection with three-dimensional rendering for CT and MR angiography images.

25. The method of claim 22, wherein the software protocols include a protocol for composite rendering for gray scale rendering of MR images.

26. The method of claim 22, wherein the software protocols include a protocol for three-dimensional rendering of the image on a user's computer.

27. (canceled)

28. A system for remote image organization and analysis, the system comprising:
at least one remotely-accessible computer including a processor; and
a software program stored on a non-transitory computer readable medium accessible by the processor, the software program being operable to
create at least one multi-dimensional library of image data,
supplement the library by adding at least one new image to the library,
share at least one image in the library between a plurality of users, wherein at least one user remotely accesses the computer, and
perform at least one computational or analytical function related to an image in the library,
wherein the computer is connected in a cloud computing configuration and the library is remotely accessible by a plurality of users via a cloud.
